(19) United States
(12) Patent Application Publication
(10) Pub. No.: US 2026/0112668 A1
(43) Pub. Date: Apr. 23, 2026

(54) Device and Method for Controlling Operation of Fuel Cell Stack

(71) Applicants: Hyundai Motor Company, Seoul (KR); Kia Corporation, Seoul (KR)

(72) Inventors: Jae Won Jung, Hwaseong-Si (KR); Jae Won Jang, Hwaseong-Si (KR); Dae Jong Kim, Hwaseong-Si (KR); Jae Kwon Jung, Hwaseong-Si (KR)

(21) Appl. No.: 19/172,141

(22) Filed: Apr. 7, 2025

(30) Foreign Application Priority Data
Oct. 17, 2024 (KR) 10-2024-0142399

(51) Int. Cl. H01M 8/04858; H01M 8/04303; H01M 8/0432; H01M 8/04537; H01M 8/04992

(52) U.S. Cl. CPC H01M 8/0488; H01M 8/04303; H01M 8/04358; H01M 8/04589; H01M 8/04626; H01M 8/04992; H01M 2250/20

(57) ABSTRACT

An apparatus may comprise a battery, a fuel cell stack, a processor, and a memory storing at least one instruction. The instruction, when executed by the processor communicating with the memory, may cause the apparatus to detect a coolant temperature of the fuel cell stack and a state of charge (SOC) of the battery, determine a temperature difference between the coolant temperature and a target coolant temperature and determine an SOC difference between the SOC and a target SOC, determine, based on the temperature difference and SOC difference, a control voltage of the fuel cell stack, determine, based on a ratio of an actual current to a reference current of the fuel cell stack, a deterioration index associated with the fuel cell stack, adjust, based on the deterioration index, the control voltage, and perform, based on the adjusted control voltage, at least one operation of the fuel cell stack.

### CROSS-REFERENCE TO RELATED APPLICATION

This application claims the benefit of priority to Korean Patent Application No. 10-2024 0142399, filed in the Korean Intellectual Property Office on Oct. 17, 2024, the entire contents of which are incorporated herein by reference.

### TECHNICAL FIELD

The present disclosure relates to a technology for controlling the operation of a fuel cell stack such that a cold shutdown (CSD) function is smoothly performed.

### BACKGROUND

The matters described in this Background section are only for the enhancement of understanding of the background of the disclosure, and should not be taken as acknowledgment that they correspond to prior art already known to those skilled in the art.

A fuel cell system is a type of power generation system that directly converts the chemical energy of fuel into electrical energy electrochemically inside a fuel cell stack, rather than converting it into heat through combustion.

A fuel cell system includes a fuel cell stack that generates electric energy, a hydrogen supply device that supplies hydrogen as fuel to the fuel cell stack, an air supply device that supplies air (oxygen) as an oxidizer necessary for an electrochemical reaction to the fuel cell stack, a thermal management system (TMS) that discharges reaction heat of the fuel cell stack to the outside of the system, controls the operating temperature of the fuel cell stack, and performs a water management function, and a fuel cell system controller that controls the overall operation of the fuel cell system. With such a configuration, the fuel cell system generates electricity by reacting hydrogen as fuel with oxygen in the air, and emits heat and water as reaction byproducts.

One type of fuel cell for vehicles is a proton exchange membrane fuel cell or polymer electrolyte membrane fuel cell (PEMFC), which has a relatively high power density among fuel cells, and has a relatively fast start-up time and a relatively fast power conversion response time due to its relatively low operating temperature.

A fuel cell stack mounted on an proton exchange membrane fuel cell includes a membrane electrode assembly (MEA) in which electrodes (i.e., catalyst layers) on both sides of a polymer electrolyte membrane through which hydrogen ions move are attached, a gas diffusion layer (GDL) that evenly distributes reaction gases and transfers the generated electricity, a gasket and a fastening member that maintains the airtightness and appropriate fastening pressure of reaction gases and cooling water, and a bipolar plate that directs reaction gases and cooling water, and generates electric current by causing a chemical reaction of hydrogen and oxygen.

In addition, the fuel cell system may be equipped with a humidifier that humidifies the air supplied to the fuel cell stack. The humidifier transfers moisture between the air exhausted from the fuel cell stack and the air supplied to the fuel cell stack through the compressor. A membrane humidifier may transfer moisture in the air discharged from the fuel cell stack to the air newly supplied to the fuel cell stack by using the membrane inside the humidifier. In the case, the performance of the membrane humidifier is determined by the humidification performance, that is, the moisture transfer/exchange performance, of the internal membrane (hereinafter referred to as the ‘humidification membrane’) that constitutes the humidifier.

A superior humidification performance of the humidifying film may mean that the humidification membrane film holds and transfers a relatively large amount of moisture. Accordingly, when the humidification performance is improved by replacing the humidifying membrane with a higher-performing variant, the membrane humidifier not only transfers moisture in a vapor state to the air supplied to the fuel cell stack to humidify it, but also transfers condensed moisture (condensate) in a liquid state discharged together with the air from the fuel cell stack, such that the condensate is supplied to the fuel cell stack together with the air.

The condensate that flows into the fuel cell stack in such a manner causes non-uniformity in the performance of stack cells (i.e., fuel cells) that constitute the fuel cell stack, and also causes a voltage drop (or cell dropout phenomenon) in some stack cells. When the cell dropout phenomenon occurs, the output of the fuel cell stack may be limited, which has a negative effect of reducing the performance efficiency of the fuel cell system.

Water remaining in the fuel cell stack not only interferes with the supply of hydrogen and oxygen, but also reduces the effective reaction area, posing operational challenges for the fuel cell stack. For example, when the operation of a fuel cell stack is terminated in a low-temperature environment, residual water remaining inside the fuel cell stack may freeze, which not only impedes smooth supply of oxygen and hydrogen, but also hinders the normal chemical reaction between oxygen and hydrogen, potentially impacting the performance of the fuel cell stack. In particular, smooth start-up may not be secured even when the fuel cell system is restarted after a certain period of time has passed since the system was shut down.

Accordingly, the fuel cell system may perform a cold shutdown (CSD) function to prevent the fuel cell stack from being damaged by discharging and removing water remaining inside the fuel cell stack in a no-load state for a specified time period when the operation of the fuel cell stack is terminated in a low-temperature environment.

The CSD function may be used to prevent the fuel cell stack from being damaged due to freezing of water remaining inside the fuel cell stack in a low-temperature environment (e.g., winter). To ensure proper execution of the CSD function, the coolant temperature of the fuel cell stack may be increased in advance. Since battery power is used to raise the coolant temperature of the fuel cell stack, the battery may be sufficiently charged in advance.

However, up to date, there has been no discussion on a method of controlling the operation of a fuel cell stack so that the CSD function is performed smoothly. In particular, there has been no proposal for a method of determining the control voltage of a fuel cell stack, and there has been no proposal for a scheme of compensating the determined control voltage.

### SUMMARY

The present disclosure has been made to solve the above-mentioned problems.

According to the present disclosure, an apparatus may comprise a battery, a fuel cell stack, and a processor, and a memory storing at least one instruction that is configured, when executed by the processor communicating with the memory, to cause the apparatus to detect a coolant temperature of the fuel cell stack and a state of charge (SOC) of the battery, determine a temperature difference between the coolant temperature of the fuel cell stack and a target coolant temperature of the fuel cell stack and determine an SOC difference between the SOC of the battery and a target SOC of the battery, determine, based on the temperature difference and the SOC difference, a control voltage of the fuel cell stack, determine, based on a ratio of an actual current of the fuel cell stack to a reference current of the fuel cell stack, a deterioration index associated with the fuel cell stack, and adjust, based on the deterioration index, the control voltage, and perform, based on the adjusted control voltage, at least one operation of the fuel cell stack.

The apparatus may further comprise storage configured to store a lookup table indicating at least one control voltage, at least one temperature difference between a target coolant temperature of the fuel cell stack and a current coolant temperature of the fuel cell stack, and at least one SOC difference between a target SOC of the battery and a current SOC of the battery.

The apparatus, wherein at least one instruction is configured, when executed by the processor communicating with the memory, to cause the apparatus to determine, based on the at least one temperature difference of the lookup table and the at least one SOC difference of the lookup table, the control voltage, wherein the determined control voltage corresponds to the determined temperature difference and the determined SOC difference.

The apparatus, wherein the at least one instruction is configured, when executed by the processor communicating with the memory, to cause the apparatus to determine periodically the temperature difference and the SOC difference at preset intervals, and update periodically, based on the temperature difference and the SOC difference, the control voltage.

The apparatus, wherein the at least one instruction is configured, when executed by the processor communicating with the memory, to cause the apparatus to determine the deterioration index by measuring the actual current of the fuel cell stack, and determining, based on the control voltage, the reference current of the fuel cell stack.

The apparatus, wherein the at least one instruction is configured, when executed by the processor communicating with the memory, to cause the apparatus to determine a first heat amount of the fuel cell stack and a first charge amount of the battery, wherein the first heat amount is less than an expected heat amount and the first charge amount is less than an expected charge amount due to deterioration of the fuel cell stack, determine a second heat amount of the fuel cell stack and a second charge amount of the battery, wherein the second heat amount increases due to adjustment of the control voltage of the fuel cell stack, and adjust the control voltage based on a voltage value that reduces a sum of a first difference and a second difference, wherein the first difference is a difference between the first heat amount of the fuel cell stack and the second heat amount of the fuel cell stack, and wherein the second difference is a difference between the first charge amount of the battery and the second charge amount of the battery.

The apparatus, wherein the at least one instruction is configured, when executed by the processor communicating with the memory, to cause the apparatus to, based on the coolant temperature of the fuel cell stack reaching the target coolant temperature of the fuel cell stack and the SOC of the battery reaching the target SOC of the battery, terminate the at least one operation of the fuel cell stack.

The apparatus, wherein the at least one instruction is configured, when executed by the processor communicating with the memory, to cause the apparatus to activate, based on the at least one operation of the fuel cell stack being terminated, a cold shutdown function associated with the fuel cell stack.

According to the present disclosure, a method performed by an apparatus of a vehicle, the method may comprise detecting, via at least one sensor of the vehicle, a coolant temperature of a fuel cell stack and a state of charge (SOC) of a battery, determining a temperature difference between the coolant temperature of the fuel cell stack and a target coolant temperature of the fuel cell stack and determining an SOC difference between the SOC of the battery and a target SOC of the battery, determining, based on the temperature difference and the SOC difference, a control voltage of the fuel cell stack, determining, based on a ratio of an actual current of the fuel cell stack to a reference current of the fuel cell stack, a deterioration index associated with the fuel cell stack, adjusting, based on the deterioration index, the control voltage, and performing, based on the adjusted the control voltage, at least one operation of the fuel cell stack.

The method may further comprise storing a lookup table indicating at least one control voltage, at least one temperature difference between a target coolant temperature of the fuel cell stack and a current coolant temperature of the fuel cell stack, and at least one SOC difference between a target SOC of the battery and a current SOC of the battery.

The method, wherein the determining the control voltage may comprise determining, based on the at least one temperature difference of the lookup table and the SOC difference of the lookup table, the at least one control voltage, and wherein the determined control voltage corresponds to the determined temperature difference and the determined SOC difference.

The method, wherein the determining the temperature difference and the SOC difference may comprise determining periodically the temperature difference and the SOC difference at preset intervals.

The method, wherein the determining the deterioration index may comprise measuring, the actual current of the fuel cell stack, and determining, based on the control voltage, the reference current of the fuel cell stack.

The method, wherein the adjusting the control voltage may comprise determining a first heat amount of the fuel cell stack and a first charge amount of the battery, wherein the first heat amount is less than an expected heat amount and the first charge amount is less than an expected charge amount due to deterioration of the fuel cell stack, determining a second heat amount of the fuel cell stack and a second charge amount of the battery, wherein the second heat amount increases due to adjustment of the control voltage of the fuel cell stack, and adjusting the control voltage based on a voltage value that reduces a sum of a first difference and a second difference, wherein the first difference is a difference between the first heat amount of the fuel cell stack and the second heat amount of the fuel cell stack, and wherein the second difference is a difference between the first charge amount of the battery and the second charge amount of the battery.

The method may further comprise based on the coolant temperature of the fuel cell stack reaching the target coolant temperature and the SOC of the battery reaching the target SOC of the battery, terminating the at least one operation of the fuel cell stack.

The method may further comprise activating, based on the at least one operation of the fuel cell stack being terminated, a cold shutdown function associated with the fuel cell stack.

According to the present disclosure, an apparatus of a vehicle, the vehicle may comprise a processor, and a memory storing at least one instruction that is configured, when executed by the processor communicating with the memory, to cause the apparatus to detect a current temperature of a coolant of the fuel cell stack of the vehicle and a state of charge (SOC) of a battery of the vehicle, determine a target condition based on at least one of a desired temperature adjustment of the current temperature of the coolant of the fuel cell stack, or a desired charge level adjustment of the SOC of the battery, determine, based on the target condition, a control voltage of the fuel cell stack, adjust, based on a parameter indicative of a degraded condition of the fuel cell stack, the control voltage, and perform, based on the adjusted control voltage, at least one operation of the fuel cell stack until the target condition is reached.

The apparatus, wherein the at least one instruction is configured, when executed by the processor communicating with the memory, to cause the apparatus to update the parameter based on a difference between actual current of the fuel cell stack and expected current of the fuel cell stack.

The apparatus, wherein the at least one instruction is configured, when executed by the processor communicating with the memory, to cause the apparatus to periodically adjust the control voltage based on changes in the degraded condition of the fuel cell stack.

The apparatus, wherein the at least one instruction is configured, when executed by the processor communicating with the memory, to cause the apparatus to activate, based on the at least one operation being terminated, a shutdown function associated with the fuel cell stack.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a device for controlling operation of a fuel cell stack according to an example of the present disclosure;

FIG. 2 shows an example of an operation of compensating a control voltage of a fuel cell stack by a controller provided in a device for controlling operation of a fuel cell stack according to an example of the present disclosure;

FIG. 3 shows an example of a process of determining a heat generation power amount of a fuel cell stack and a first charging power amount of a battery which are reduced or become insufficient or deficient (e.g., less than a threshold amount) due to deterioration of the fuel cell stack by a controller provided in a device for controlling operation of a fuel cell stack according to an example of the present disclosure;

FIG. 4 shows an example of a heat generation amount of a fuel cell stack and a charging power amount of a battery which are increased due to adjustment of a control voltage of the fuel cell stack by a controller provided in a device for controlling operation of a fuel cell stack according to an example of the present disclosure;

FIG. 5 shows an example of a first performance analysis of a device for controlling operation of a fuel cell stack according to an example of the present disclosure;

FIG. 6 shows an example of a second performance analysis of a device for controlling operation of a fuel cell stack according to an example of the present disclosure;

FIG. 7 shows an example of a method of controlling operation of a fuel cell stack according to an example of the present disclosure;

FIG. 8 shows an example of a method of controlling operation of a fuel cell stack according to an example of the present disclosure;

FIG. 9 shows an example of a computing system for executing a method of controlling operation of a fuel cell stack according to each example of the present disclosure; and

FIG. 10 shows an example of a lookup table in which a control voltage corresponding to a ΔT and a ΔSOC.

### DETAILED DESCRIPTION

Hereinafter, some examples of the present disclosure will be described in detail with reference to the exemplary drawings. In adding the reference numerals to the components of each drawing, it should be noted that the identical or equivalent component is specified by the identical numeral even when they are displayed on other drawings. Further, in describing the example of the present disclosure, a detailed description of the related known configuration or function will be omitted when it is determined that it interferes with the understanding of the example of the present disclosure.

In addition, terms, such as first, second, A, B, (a), (b) or the like may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

According to the present disclosure, in fuel cell vehicles, especially during cold winter conditions, the fuel cell stack, which generates electricity from hydrogen, may freeze or perform poorly when cold water remains trapped inside. To solve these problems, a method for managing the temperature and battery charge simultaneously before shutting down the vehicle is considered. Specifically, the method involves warming the coolant water inside the fuel cell stack to prevent freezing and charging the vehicle's battery to ensure enough power for this warming process. Using a fixed control voltage of the fuel cell based on predictions may not be flexible enough if the fuel cell stack performance decreases over time. The method may improve on that by continuously adjusting the control voltage according to real-time performance of the fuel cell stack. The method may do so by periodically reassessing and updating the control voltage, compensating for any performance degradation in the fuel cell stack. This may ensure the vehicle reliably meets target temperatures and battery charge levels, ensuring desirable pre-shutdown conditions to prevent freeze-related damage and facilitate proper restart conditions of the fuel cell.

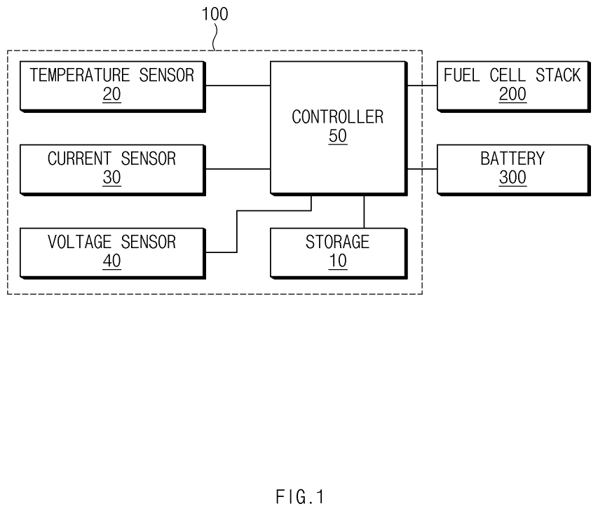

FIG. 1 shows an example of a device for controlling operation of a fuel cell stack according to an example of the present disclosure.

As illustrated in FIG. 1, a device 100 for controlling operation of a fuel cell stack according to an example of the present disclosure may include storage 10 (e.g., RAM, ROM, flash memory, or SSD, etc.), a temperature sensor 20 (e.g., thermistors, thermocouples, RTDs, or infrared sensors, etc.), a current sensor 30 (e.g., Hall-effect sensors, shunt resistors, or Rogowski coils, etc.), a voltage sensor 40 (e.g., voltmeters, voltage dividers, or differential amplifiers, etc.), and a controller 50 (e.g., a circuit, circuitry, a microcontroller, processor, microprocessor, FPGA, or CPU, etc.). In this case, depending on a scheme of implementing the device 100 for controlling operation of a fuel cell stack according to an example of the present disclosure, components may be combined with each other to be implemented as one, or some components may be omitted. The device may be equipped in a vehicle with one or more batteries and the fuel cell stack.

One or more controllers described herein may include a communication device communicating with other controllers or a sensor to control one or more functions and/or operations in charge, a memory storing an operation system, a logic command, and input/output information, and/or one or more processors performing determination, calculation, and decision necessary for controlling the function in charge. A controller may include, for example, a processor, a central processing unit (CPU), a microchip, a logic, an application-specific integrated circuit (ASIC), memory, etc. A controller may manipulate and/or control other components in the system (e.g., vehicle).

One or more sensors may be equipped in the vehicle. The sensor(s) may include, for example, a temperature sensor, a charger connection sensor, a voltage sensor, a current sensor, a power sensor, a camera, a LIDAR, a radar, an infrared sensor, an infrared camera, a thermal imaging camera, a blind spot monitoring sensor, a line departure warning sensor, a parking sensor, a light sensor, a rain sensor, a traction control sensor, an anti-lock braking system sensor, a tire pressure monitoring sensor, a seatbelt sensor, an airbag sensor, a fuel sensor, an emission sensor, a throttle position sensor, a gyroscope, a speedometer, a magnetometer, etc. The sensor may be used, for example, for fuel cell operation control, autonomous driving control, etc.

Regarding each component, first, the storage 10 may store various logic, algorithms and programs required in the process of detecting a coolant temperature of a fuel cell stack 200 and a state-of-charge (SOC) of a battery 300 when a shutdown function (e.g., a CSD function of the fuel cell stack) is activated, determining a temperature difference compared to a target temperature and an SOC difference compared to a target SOC, determining a control voltage corresponding to the temperature difference and the SOC difference, controlling the operation of the fuel cell stack 200 with the control voltage, determining a ratio of an actual current to a reference current of the fuel cell stack 200 as a deterioration index, and compensating the control voltage based on the deterioration index.

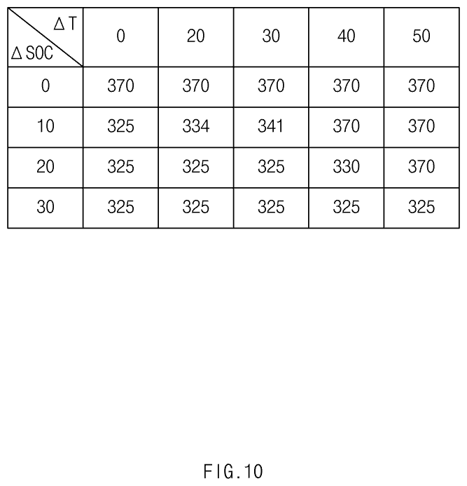

The storage 10 may store a data set (e.g., a lookup table) in which a control voltage (V) corresponding to the temperature difference (ΔT) between a target coolant temperature and a current coolant temperature of the fuel cell stack 200 and the SOC difference (ΔSOC) between a target SOC and a current SOC of the battery 300 is recorded. For example, the lookup table may include at least one control voltage value or a plurality of control voltage values, each control voltage value indexed by two differences (e.g., a corresponding temperature difference and a corresponding SOC difference). For example, the lookup table may comprise N×M matrix (e.g., 4 by 5 matrix). The matrix may include a first row listing a plurality of temperature differences (e.g., ΔT1, ΔT2, . . . , ΔT4) and a first column listing a plurality of SOC differences (e.g., ΔSOC1, ΔSOC2, . . . , ΔSOC5). For example, one of the plurality of temperature differences in the first row and one of the plurality of SOC differences in the first column may indicate their corresponding control voltage value (e.g., ΔT2 and ΔSOC3 corresponding to one of 4×5 different control voltage values). The lookup table is shown in FIG. 10

The storage 10 may further store the lookup table in which a reference current corresponding to the control voltage (V) is recorded. For example, the lookup table may include at least one reference current or a plurality of reference currents, each reference current indexed by a corresponding control voltage value.

The storage 10 may store various logic, algorithms and programs required in the process of detecting the coolant temperature of the fuel cell stack 200 and the SOC of the battery 300 when the shutdown function (e.g., the CSD function of the fuel cell stack) is activated, determining a temperature difference compared to a target temperature and an SOC difference compared to a target SOC, determining the control voltage corresponding to the temperature difference and the SOC difference based on the lookup table, controlling the operation of the fuel cell stack 200 with the control voltage, determining a ratio of an actual current to a reference current of the fuel cell stack 200 as a deterioration index, and compensating the control voltage based on the deterioration index.

In order to determine the ratio of an actual current to the reference current of the fuel cell stack 200 as the deterioration index, and compensate the control voltage based on the deterioration index, the storage 10 may store various logic, algorithms and programs required for determining a first heat generation power amount of the fuel cell stack 200 and a first charging power amount of the battery 300 which are reduced or become insufficient or deficient (e.g., less than a threshold amount) due to deterioration of the fuel cell stack 200, determining a second heat generation power amount of the fuel cell stack 200 which increases due to adjustment of the control voltage of the fuel cell stack 200 and a second charging power amount of the battery 300, and determining a voltage that minimizes the sum (i.e., the summing result) of a difference between the first heat generation power amount and the second heat generation power amount of the fuel cell stack 200 and a difference between the first charging power amount and the second charging power amount of the battery 300 as a value that compensates the control voltage of the fuel cell stack 200.

The temperature sensor 20 may measure the coolant temperature of the fuel cell stack 200.

The current sensor 30 may include a first current sensor that measures the output current of the fuel cell stack 200 and a second current sensor that measures the output current of the battery 300.

The voltage sensor 40 may include a first voltage sensor that measures the output voltage of the fuel cell stack 200 and a second voltage sensor that measures the output voltage of the battery 300.

The controller 50 may be electrically connected to each component and may perform overall control such that each component performs its function. The controller 50 may be implemented in the form of hardware (e.g., processor, application specific integrated circuit (ASIC), etc.) or software, or may be implemented in a combination of hardware and software. Preferably, the controller 50 may be implemented as a microprocessor, but is not limited thereto. When the shutdown function (e.g., the CSD function of the fuel cell stack) is activated, the controller 50 may obtain the coolant temperature of the fuel cell stack 200 through the temperature sensor 20, and determine the SOC of the battery 300 based on the output current of the battery 300 obtained through the current sensor 30 and the output voltage of the battery 300 obtained through the voltage sensor 40. Any feasible scheme (e.g., coulomb counting, voltage-based estimation, impedance spectroscopy, etc.) for determining the SOC of the battery 300 may be used.

The controller 50 may determine the difference (ΔT) between the target coolant temperature and the current coolant temperature of the fuel cell stack 200, and determine the difference (ΔSOC) between the target SOC and the current SOC of the battery 300. For example, the target coolant temperature (e.g., 65° C.) of the fuel cell stack 200 and the target SOC (e.g., 65%) of the battery 300 may be fixed values stored in the storage 10.

The controller 50 may determine or periodically determine the difference (ΔT) between the target coolant temperature and the current coolant temperature of the fuel cell stack 200 and determine the difference (ΔSOC) between the target SOC and the current SOC of the battery 300, at preset intervals (e.g., every 5 seconds).

The controller 50 may determine the control voltage (V) of the fuel cell stack 200 based on the difference (ΔT) between the target coolant temperature and the current coolant temperature of the fuel cell stack 200 and the difference (ΔSOC) between the target SOC and the current SOC of the battery 300. In this case, the control voltage (V) may be the output voltage of the fuel cell stack 200.

The controller 50 may determine the control voltage (V) of the fuel cell stack 200 based on pre-stored data (e.g., the lookup table) in which the control voltage (V) corresponding to the difference (ΔT) between the target coolant temperature and the current coolant temperature of the fuel cell stack 200 and the difference (ΔSOC) between the target SOC and the current SOC of the fuel cell stack 200 is recorded. For example, the lookup table may include a plurality of control voltage values, each control voltage value indexed by two differences (e.g., a corresponding temperature difference (ΔT) and a corresponding SOC difference (ΔSOC). For example, the lookup table may comprise N×N matrix (e.g., 4 by 4 matrix). The matrix may include a plurality of temperature differences (e.g., ΔT1, ΔT2, . . . , ΔT4) and a plurality of SOC differences (e.g., ΔSOC1, ΔSOC2, . . . , ΔSOC4). For example, a temperature difference (e.g., ΔT2) and a SOC difference (e.g., ΔSOC3) may indicate their corresponding control voltage value (e.g., one of sixteen different control voltage values).

The controller 50 may control the operation of the fuel cell stack 200 by using the control voltage (V) and measure the output current of the fuel cell stack 200 through the current sensor 30. In this case, the controller 50 may control the fuel cell stack 200 to output the control voltage (V).

The controller 50 may determine the reference current corresponding to the control voltage (V) based on the lookup table stored in the storage 10, and determine the ratio of the output current to the reference current as the deterioration index. For example, the lookup table may include a plurality of reference currents, each reference current indexed by a corresponding control voltage value.

In order to compensate the control voltage (V) of the fuel cell stack 200 based on the deterioration index, the controller 50 may determine the first heat generation power amount of the fuel cell stack 200 that is reduced or become insufficient or deficient (e.g., less than a threshold amount) due to the deterioration of the fuel cell stack 200 and the first charging power amount of the battery 300, determine the second heat generation power amount of the fuel cell stack 200 which increases due to adjustment of the control voltage of the fuel cell stack 200 and the second charging power amount of the battery 300, and determine a voltage that reduces or minimizes the sum of the first difference between the first heat generation power amount and the second heat generation power amount of the fuel cell stack 200 and the second difference between the first charging power amount and the second charging power amount of the battery 300 (i.e., the sum of the first difference and the second difference) as a value that adjusts or compensates the control voltage of the fuel cell stack 200.

The controller 50 may terminate the operation of the fuel cell stack 200 when the coolant temperature of the fuel cell stack 200 reaches the target temperature and the SOC of the battery 300 reaches the target SOC. Thereafter, the controller 50 may activate the shutdown function (e.g., the CSD function).

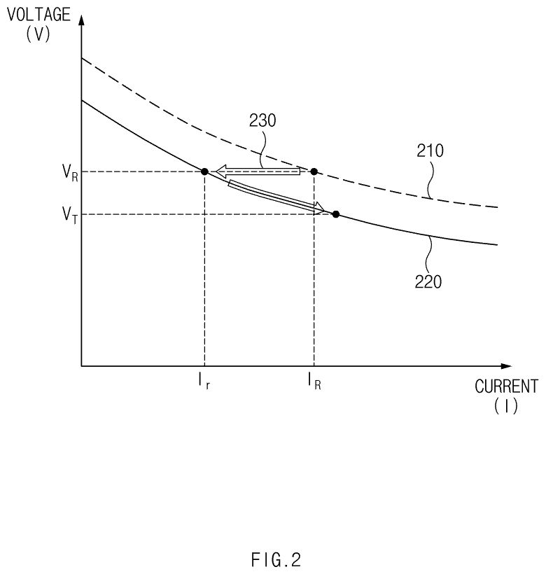

Hereinafter, the operation of the controller 50 will be described with reference to FIG. 2 to 4.

FIG. 2 shows an example of an operation of compensating a control voltage of a fuel cell stack by a controller provided in a device for controlling operation of a fuel cell stack according to an example of the present disclosure.

In FIG. 2, the horizontal axis represents current and the vertical axis represents voltage. Reference numeral 210 denotes a graph illustrating the relationship between the voltage and current of the fuel cell stack 200 in which no deterioration (e.g., aging, contamination, or physical damage, etc.) occurs, and reference numeral 220 denotes a graph illustrating the relationship between the voltage and current of the fuel cell stack 200 in which performance deterioration occurs (e.g., aging, contamination, catalyst degradation, or electrolyte deterioration, etc.).

As illustrated in FIG. 2, the controller 50 may determine the control voltage (V_{R}) of the fuel cell stack 200 based on the lookup table stored in the storage 10. However, when deterioration occurs in the fuel cell stack 200 as shown in the graph 220, an actual output current at a given voltage is reduced compared to a non-deteriorated condition (e.g., current decreases compared to at the same voltage). That is, a desired or reference current (I_{R}) may no longer be attainable under the original control voltage (V_{R}).

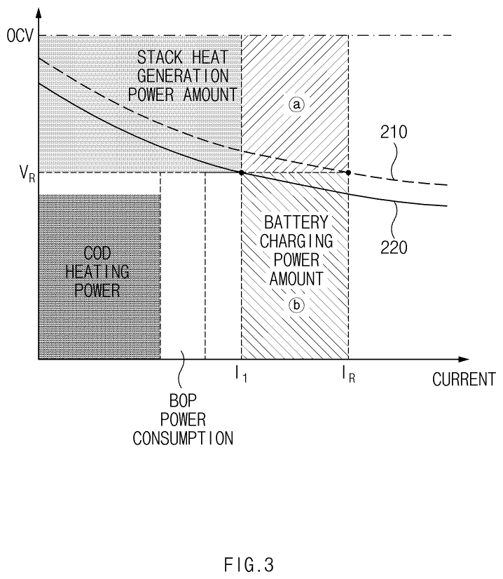

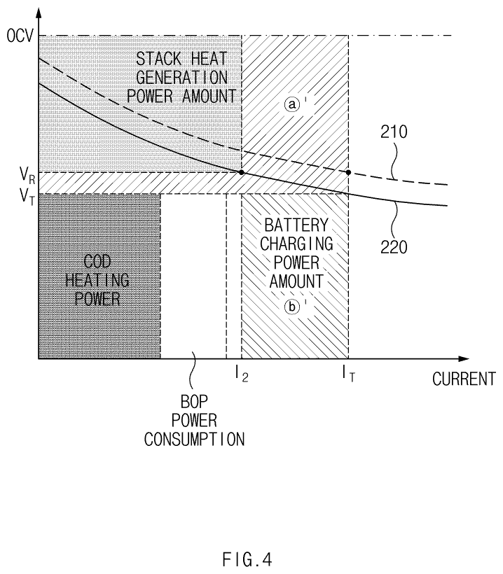

Therefore, the controller 50 may adjust the control voltage (V_{R}) of the fuel cell stack 200 to achieve the reference current (I_{R}) of the fuel cell stack 200. Specifically, for example, the controller 50 may compensate the initial control voltage (V_{R}) by a voltage difference (ΔV) to obtain an adjusted control voltage (V_{T}(=V_{R}−ΔV)). In this case, the method of obtaining ΔV is described in detail with reference to FIGS. 3 and 4.

FIG. 3 shows an example of a process by which a controller provided in a device for controlling operations of a fuel cell stack. The process may comprise determining a heat generation power amount (e.g., thermal energy, heat loss, or waste heat, etc.) of a fuel cell stack and a charging power amount (e.g., stored electrical energy or charge capacity, etc.) of a battery, which are reduced or become insufficient or deficient (e.g., less than a threshold amount) due to performance deterioration (e.g., aging, catalyst degradation, electrolyte deterioration, or contamination, etc.) of the fuel cell stack.

In FIG. 3, \textcircled{a} represents the heat generation amount (e.g., amount of thermal energy loss or dissipated heat, etc.) of the fuel cell stack 200 that becomes insufficient or reduced (e.g., less than a threshold amount) or deficient due to performance deterioration (e.g., aging, contamination, catalyst degradation, or electrolyte deterioration, etc.) of the fuel cell stack 200, and \textcircled{b} represents the charging power amount e.g., amount of available battery charge, electrical energy, or storage capacity, etc.) of the battery 300 that becomes insufficient or reduced (e.g., less than a threshold amount) due to the performance deterioration of the fuel cell stack 200. In this case, the heat generation amount of the fuel cell stack 200 refers to the amount of power consumed due to thermal energy (e.g., the heat) generated by the fuel cell stack 200.

In this case, \textcircled{a} may be expressed as following Equation 1, and \textcircled{b} may be expressed as following Equation 2.

$$= ( O C V - {V}_{R} ) \times ( {I}_{R} - {I}_{1} ) = ( O C V - {V}_{R} ) \times ( 1 - α ) \times {I}_{R} \qquad [ Equation 1 ]$$

Where V_{R} represents the control voltage obtained through the lookup table, I_{R} represents the reference current corresponding to V_{R}, I₁ represents the actual current corresponding to V_{R}, and α is I₁/I_{R} as a degradation index.

$$= {V}_{R} \times ( {I}_{R} - {I}_{1} ) = {V}_{R} \times ( 1 - α ) \times {I}_{R} \qquad [ Equation 2 ]$$

FIG. 4 shows an example of a heat generation amount of a fuel cell stack and a charging power amount of a battery which are increased due to adjustment of a control voltage of the fuel cell stack by a controller provided in a device for controlling operation of a fuel cell stack according to an example of the present disclosure.

In FIG. 4, \textcircled{a}′ represents the heat generation amount (e.g., amount of additional thermal energy, increased heat dissipation, or elevated heat output, etc.) of the fuel cell stack 200 that increases due to adjustment of the control voltage (e.g., from V_{R} to V_{T}) of the fuel cell stack 200, and \textcircled{b}′ represents the charging power amount (e.g., amount of additional battery charge, increased electrical energy, or elevated storage capacity, etc.) of the battery 300 that increases due to the adjustment of the control voltage (e.g., from V_{R} to V_{T}) of the fuel cell stack 200.

In this case, \textcircled{a}′ may be expressed as following Equation 3, and \textcircled{b}′ may be expressed as following Equation 4.

$$= ( OCV - {V}_{R} ) \times ( {I}_{T} - {I}_{2} ) + ( {V}_{R} - {V}_{T} ) \times {I}_{T} = ( OCV - {V}_{R} ) \times Δ I + Δ V \times ( {I}_{2} + Δ I ) = ( OCV - {V}_{R} + Δ V ) \times Δ I + Δ V \times {α I}_{R} \qquad [ Equation 3 ]$$

Where V_{R} represents the control voltage obtained through the lookup table, ΔV is a substituted value of V_{R}-V_{T}, ΔI is a substituted value of I_{T}-I₂, a means I₂/I_{T}, and I_{R} represents the reference current corresponding to V_{R}.

$$= ( {V}_{R} - Δ V ) \times Δ I - Δ V \times {α I}_{R} - Δ V \times \frac{2 {V}_{R} - Δ V}{R} \qquad [ Equation 4 ]$$

Where ‘R’ is a resistance that affects the cathode oxygen depletion (COD) heat generation power amount and is a constant. In this case, the balance of plant (BOP) power consumption is so small that it may be ignored. For example, BOP may include systems such as a mechanical balance of plant (M-BOP) that includes a fuel processing system (FPS), an air supply system (APS), or a thermal management system (TMS) related to the fuel cell stack 200.

Finally, the controller 50 may determine ΔV that minimizes the result value of following Equation 5 as the compensation value of the control voltage (V_{R}).

$$abs ( - ) + abs ( - ) \qquad [ Equation 5 ]$$

Where abs means an absolute value.

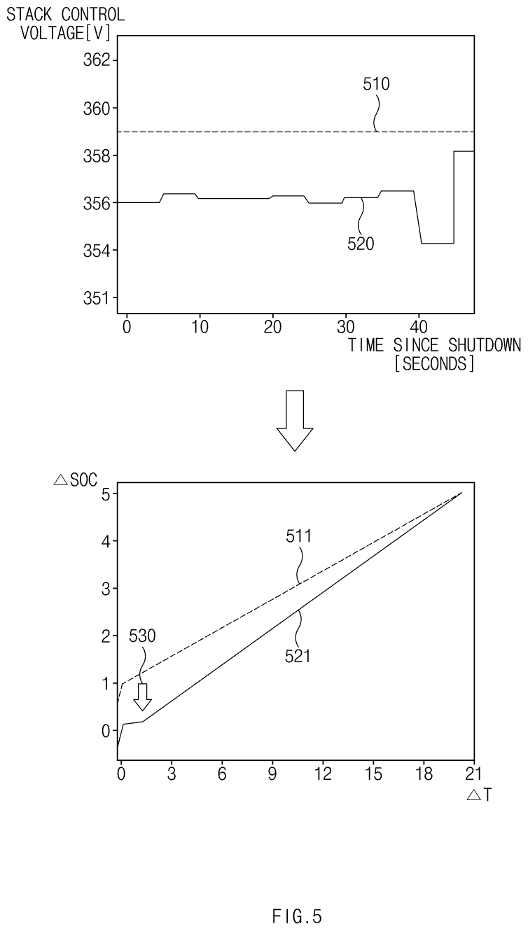

FIG. 5 shows an example of a first performance analysis of a device for controlling operation of a fuel cell stack according to an example of the present disclosure. FIG. 5 shows a performance comparison between a method using a fixed control voltage (e.g., not accounting performance deterioration) and the method of the present disclosure targeting the fuel cell stack 200 with a variable control voltage to account for performance deterioration.

In FIG. 5, reference numeral 510 represents a control voltage of the fuel cell stack 200 according to a method using the fixed control voltage, and reference numeral 520 represents a control voltage of the fuel cell stack 200 according to an example of the present disclosure. In this case, the method 510 controls the operation of the fuel cell stack 200 with a fixed control voltage, whereas the method 520 of the present disclosure controls the operation of the fuel cell stack 200 with a periodically adjusted control voltage or dynamically variable control voltage.

As a result, a performance difference 530 may occur as shown in the performance graph 511 according to the method using the fixed control voltage compared to the performance graph 521 according to the method of the present disclosure. The method using the fixed control voltage may result in an error or deviation (ΔSOC) indicated by the performance difference 530.

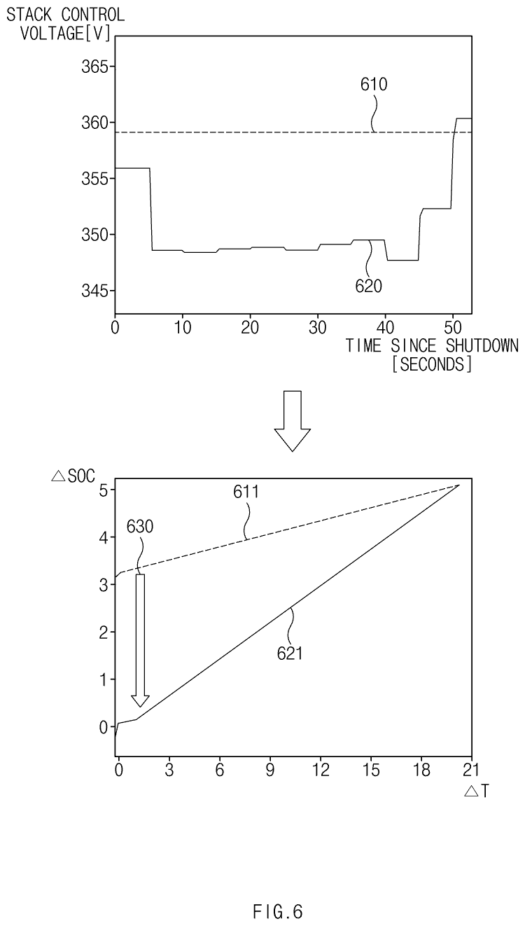

FIG. 6 shows an example of a second performance analysis of a device for controlling operation of a fuel cell stack according to an example of the present disclosure. FIG. 6 shows a performance comparison between a method using the fixed control voltage and the method of the present disclosure targeting the fuel cell stack 200 with a variable control voltage to account for performance deterioration.

In FIG. 6, reference numeral 610 represents a control voltage of the fuel cell stack 200 according to a method using the fixed control voltage, and reference numeral 620 represents a control voltage of the fuel cell stack 200 according to an example of the present disclosure. In this case, the method 610 controls the operation of the fuel cell stack 200 with a fixed control voltage, whereas the method 620 of the present disclosure controls the operation of the fuel cell stack 200 with a periodically adjusted control voltage or dynamically variable control voltage.

As a result, a significant performance difference 630 (e.g., deviation ΔSOC) occurs in the performance graph 611 according to the method using the fixed control voltage compared to the performance graph 621 according to the method of the present disclosure. That is, the method using the fixed control voltage results in a notable deviation or a significant error (ΔSOC) indicated by the performance difference 630.

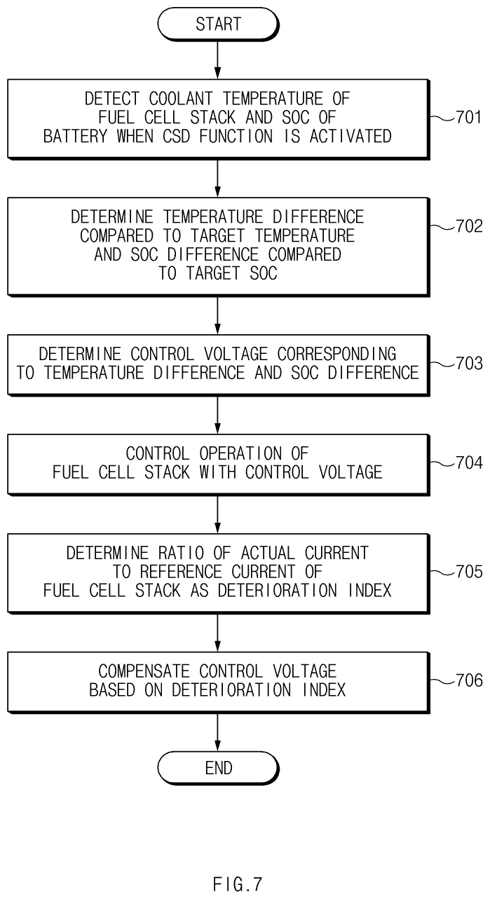

FIG. 7 shows an example of a method of controlling operation of a fuel cell stack according to an example of the present disclosure.

When the shutdown function (e.g., the CSD function of the fuel cell) is activated, in 701, the controller 50 detects the coolant temperature of the fuel cell stack and the state-of-charge (SOC) of the battery.

Then, in 702, the controller 50 determines the temperature difference compared to the target temperature and the SOC difference compared to the target SOC.

Then, in 703, the controller 50 determines a control voltage corresponding to the temperature difference and the SOC difference.

Then, in 704, the controller 50 controls the operation of the fuel cell stack with the control voltage.

Then, in 705, the controller 50 determines the ratio of the actual current to the reference current of the fuel cell stack as a deterioration index.

Then, in 706, the controller 50 compensates the control voltage based on the deterioration index.

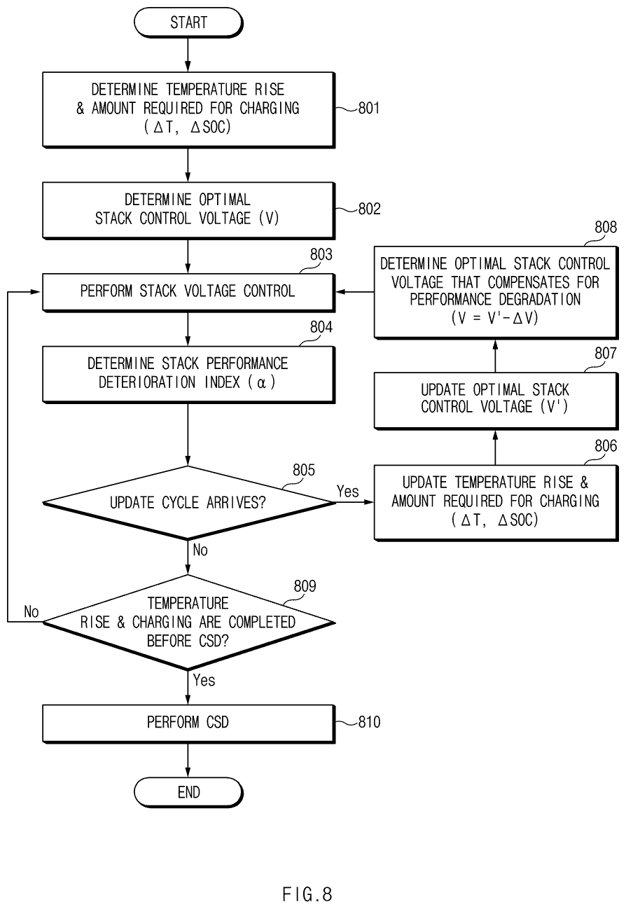

FIG. 8 shows an example of a method of controlling operation of a fuel cell stack according to an example of the present disclosure.

First, in 801, the controller 50 determines the difference (ΔT) between the current coolant temperature and the target coolant temperature of the fuel cell stack 200 and the difference (ΔSOC) between the current SOC and the target SOC of the fuel cell stack 200.

Then, in 802, the controller 50 determines the control voltage (V) corresponding to the temperature difference (ΔT) and the SOC difference (ΔSOC).

Then, in 803, the controller 50 controls the operation of the fuel cell stack 200 with the control voltage.

Then, in 804, the controller 50 determines the ratio of the actual current to the reference current of the fuel cell stack 200 as the deterioration index.

Then, in 805, the controller 50 determines whether a present update cycle (e.g., approximately every 5 seconds) has elapsed.

As the determination result in 805, when the update cycle arrives, the controller 50 updates the temperature difference (ΔT) and the SOC difference (ΔSOC) in 806.

Then, in 807, the controller 50 updates the control voltage.

Then, in 808, the controller 50 compensates the control voltage.

As the determination result in 805, when the update cycle does not arrive, in 809, the controller 50 determines whether the increase of the coolant temperature and the charging of the battery 300 are completed. That is, the controller 50 determines whether the coolant temperature of the fuel cell stack 200 reaches the target temperature and also whether the SOC of the battery 300 reaches the target SOC.

As the determination result in 809, if the target temperature and the SOC of the battery have not yet reached (e.g., the increase of the coolant temperature and the charging of the battery 300 are not completed), the process returns to operation 803.

As the determination result in 809, if the target temperature and the SOC of the battery have been successfully reached (e.g., the increase of the coolant temperature and the charging of the battery 300 are completed), in 810, the controller 50 activates the shutdown function (e.g., the CSD function) of the fuel cell.

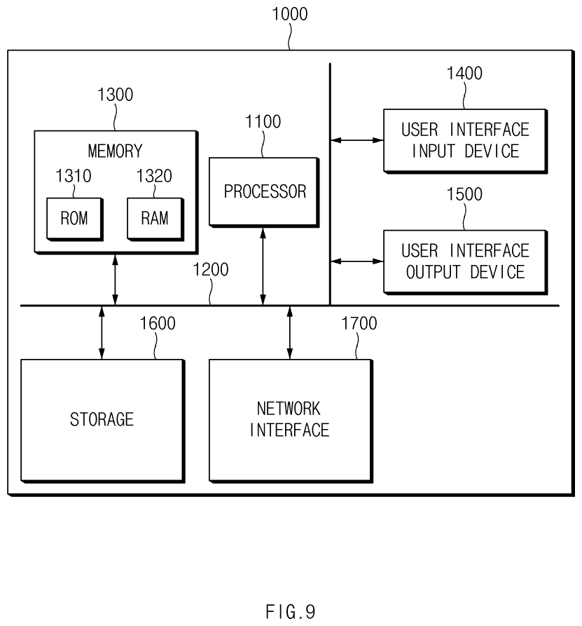

FIG. 9 shows an example of a computing system for executing a method of controlling operation of a fuel cell stack according to each example of the present disclosure.

Referring to FIG. 9, as described above, the method of controlling operation of a fuel cell stack according to an example of the present disclosure may be implemented through a computing system 1000. The computing system 1000 may include at least one processor 1100 (e.g., CPU, GPU, microcontroller, etc.), a memory 1300 (e.g., RAM, ROM, flash memory, etc.), a user interface input device 1400 (e.g., touchscreen, keyboard, mouse, etc.), a user interface output device 1500 (e.g., display, speaker, etc.), storage 1600 (e.g., SSD, HDD, cloud storage, etc.), and a network interface 1700 (e.g., Ethernet, Wi-Fi, cellular, etc.) which are connected through a system bus 1200.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) 1310 and a random access memory (RAM) 1320.

Accordingly, the processes of the method or algorithm described in relation to the examples of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

One aspect of the present disclosure provides a device and method for controlling operation of a fuel cell stack that enable the fuel cell stack to produce optimal energy required for smooth performance of a cold shutdown (CSD) function by detecting a coolant temperature of the fuel cell stack and a state of charge (SOC) of a battery when the CSD function is activated, determining a temperature difference compared to a target temperature and an SOC difference compared to a target SOC, determining a control voltage corresponding to the temperature difference and the SOC difference, controlling the operation of the fuel cell stack with the control voltage, determining a ratio of an actual current to a reference current of the fuel cell stack as a deterioration index, and compensating the control voltage based on the deterioration index.

In this case, according to an example of the present disclosure, the operation of the fuel cell stack may be controlled using the control voltage, an output current of the fuel cell stack may be measured, a reference current may be determined corresponding to the control voltage, and the ratio of the output current to the reference current may be determined as the deterioration index.

Another aspect of the present disclosure provides a device and method for controlling operation of a fuel cell stack that enable the fuel cell stack to produce optimal energy required for smooth performance of a cold shutdown (CSD) function by providing a lookup table in which a control voltage corresponding to the difference between a current temperature and a target temperature of a coolant and the difference between a current SOC and a target SOC of the fuel cell stack is recorded, detecting the coolant temperature of the fuel cell stack and an SOC of a battery when the CSD function is activated, determining a temperature difference compared to the target temperature and an SOC difference compared to the target SOC, determining a control voltage corresponding to the temperature difference and the SOC difference based on the look-up table, controlling the operation of the fuel cell stack with the control voltage, determining a ratio of an actual current to a reference current of the fuel cell stack as a deterioration index, and compensating the control voltage based on the deterioration index.

In this case, according to another example of the present disclosure, the operation of the fuel cell stack may be controlled using the control voltage, an output current of the fuel cell stack may be measured, a reference current may be determined corresponding to the control voltage, and the ratio of the output current to the reference current may be determined as the deterioration index.

Still another aspect of the present disclosure provides a device and method for controlling operation of a fuel cell stack that enable the fuel cell stack to produce optimal energy required for smooth performance of a cold shutdown (CSD) function and reach a target temperature and target SOC during a specified operation time when CSD is performed after stopping by determining a first heat generation power amount of the fuel cell stack and a first charging power amount of a battery, which are insufficient due to deterioration of the fuel cell stack, determining a second heat generation power amount of the fuel cell stack which increases due to adjustment of a control voltage of the fuel cell stack and a second charging power amount of the battery, and determining a voltage (i.e., a voltage that minimize a sum) that minimizes a sum of a first difference between a first heat generation power amount and a second heat generation power amount of the fuel cell stack and a second difference between a first charging power amount and a second charging power amount of the battery (i.e., a sum of the first difference and the second difference) as a value that compensates the control voltage of the fuel cell stack (i.e., an optimal compensation voltage) in determining the ratio of an actual current to a reference current of the fuel cell stack as a deterioration index and compensating the control voltage of the fuel cell stack based on the deterioration index.

The technical problems to be solved by the present disclosure are not limited to the aforementioned problems, and any other technical problems not mentioned herein will be clearly understood from the following description by those skilled in the art to which the present disclosure pertains. Also, it may be easily understood that the objects and advantages of the present disclosure may be realized by the units and combinations thereof recited in the claims.

According to one aspect of the present disclosure, a device for controlling operation of a fuel cell stack includes a battery, the fuel cell stack, and a controller electrically connected to the battery and the fuel cell stack, wherein the controller may detect a coolant temperature of the fuel cell stack and a state of charge (SOC) of the battery when a cold shutdown (CSD) function is activated, determine a temperature difference compared to a target temperature and an SOC difference compared to a target SOC, determine a control voltage corresponding to the temperature difference and the SOC difference, control the operation of the fuel cell stack with the control voltage, determine a ratio of an actual current to a reference current of the fuel cell stack as a deterioration index, and compensate the control voltage based on the deterioration index.

According to an example, the device may further include storage that stores a lookup table in which a control voltage corresponding to a difference between a target coolant temperature and a current coolant temperature of the fuel cell stack and a difference between the target SOC and a current SOC of the battery is recorded.

According to an example, the controller may determine the control voltage corresponding to the temperature difference and the SOC difference based on the lookup table.

According to an example, the controller may determine the temperature difference compared to the target temperature and the SOC difference compared to the target SOC at preset intervals, and determine the control voltage corresponding to the temperature difference and the SOC difference.

According to an example, the controller may measure an output current of the fuel cell stack, determine a reference current corresponding to the control voltage, and determine a ratio of the output current to the reference current as the deterioration index.

According to an example, the controller may determine a first heat generation power amount of the fuel cell stack and a first charging power amount of a battery, which are insufficient due to deterioration of the fuel cell stack, determine a second heat generation power amount of the fuel cell stack which increases due to adjustment of the control voltage of the fuel cell stack and a second charging power amount of the battery, and compensate the control voltage based on a voltage that minimizes a sum of a difference between the first heat generation power amount and the second heat generation power amount of the fuel cell stack and a difference between the first charging power amount and the second charging power amount of the battery.

According to an example, the controller may terminate the operation of the fuel cell stack when the coolant temperature of the fuel cell stack reaches the target temperature and the SOC of the battery reaches the target SOC.

According to an example, the controller may activate the CSD function when the operation of the fuel cell stack is terminated.

According to another aspect of the present disclosure, a method of controlling operation of a fuel cell stack includes detecting, by a controller, a coolant temperature of the fuel cell stack and a state of charge (SOC) of a battery when a cold shutdown (CSD) function is activated, determining, by the controller, a temperature difference compared to a target temperature and an SOC difference compared to a target SOC, determining, by the controller, a control voltage corresponding to the temperature difference and the SOC difference, controlling, by the controller, the operation of the fuel cell stack with the control voltage, determining, by the controller, a ratio of an actual current to a reference current of the fuel cell stack as a deterioration index, and compensating, by the controller, the control voltage based on the deterioration index.

According to an example, the method may further include storing, by storage, a lookup table in which a control voltage corresponding to a difference between a target coolant temperature and a current coolant temperature of the fuel cell stack and a difference between the target SOC and a current SOC of the battery are recorded.

According to an example, the determining of the control voltage may include determining, by the controller, the control voltage corresponding to the temperature difference and the SOC difference based on the lookup table.

According to an example, the determining of the temperature difference and the SOC difference may include determining, by the controller, the temperature difference compared to the target temperature and the SOC difference compared to the target SOC at preset intervals.

According to an example, the determining of the ratio of the actual current to the reference current as the deterioration index may include measuring, by the controller, an output current of the fuel cell stack, and determining, by the controller, a reference current corresponding to the control voltage.

According to an example, the compensating of the deterioration index may include determining, by the controller, a first heat generation power amount of the fuel cell stack and a first charging power amount of a battery, which are insufficient due to deterioration of the fuel cell stack, determining, by the controller, a second heat generation power amount of the fuel cell stack which increases due to adjustment of the control voltage of the fuel cell stack and a second charging power amount of the battery, and compensating, by the controller, the control voltage based on a voltage that minimizes a sum of a difference between the first heat generation power amount and the second heat generation power amount of the fuel cell stack and a difference between the first charging power amount and the second charging power amount of the battery.

According to an example, the method may further include terminating, by the controller, the operation of the fuel cell stack when the coolant temperature of the fuel cell stack reaches the target temperature and the SOC of the battery reaches the target SOC.

According to an example, the method may further include activating, by the controller, the CSD function when the operation of the fuel cell stack is terminated.

According to the other aspect of the present disclosure, a device for controlling operation of a fuel cell stack includes a processor, and a non-transitory storage medium containing program instructions that, when executed by the processor causes the device to detect a coolant temperature of the fuel cell stack and a state of charge (SOC) of the battery when a cold shutdown (CSD) function is activated, determine a temperature difference compared to a target temperature and an SOC difference compared to a target SOC, determine a control voltage corresponding to the temperature difference and the SOC difference, control the operation of the fuel cell stack with the control voltage, determine a ratio of an actual current to a reference current of the fuel cell stack as a deterioration index, and compensate the control voltage based on the deterioration index.

According to the examples of the present disclosure, it is possible to enable the fuel cell stack to produce optimal energy required for smooth performance of a CSD function by detecting a coolant temperature of the fuel cell stack and the SOC of a battery when the CSD function is activated, determining a temperature difference compared to a target temperature and an SOC difference compared to a target SOC, determining a control voltage corresponding to the temperature difference and the SOC difference, controlling the operation of the fuel cell stack with the control voltage, determining a ratio of an actual current to a reference current of the fuel cell stack as a deterioration index, and compensating the control voltage based on the deterioration index.

The above description is a simple exemplification of the technical spirit of the present disclosure, and the present disclosure may be variously corrected and modified by those skilled in the art to which the present disclosure pertains without departing from the essential features of the present disclosure. Therefore, the disclosed examples of the present disclosure do not limit the technical spirit of the present disclosure but are illustrative, and the scope of the technical spirit of the present disclosure is not limited by the examples of the present disclosure. The scope of the present disclosure should be construed by the claims, and it will be understood that all the technical spirits within the equivalent range fall within the scope of the present disclosure.

What is claimed:

1. An apparatus comprising:
a battery;
a fuel cell stack; and
a processor; and
a memory storing at least one instruction that is configured, when executed by the processor communicating with the memory, to cause the apparatus to:
detect a coolant temperature of the fuel cell stack and a state of charge (SOC) of the battery,
determine a temperature difference between the coolant temperature of the fuel cell stack and a target coolant temperature of the fuel cell stack and determine an SOC difference between the SOC of the battery and a target SOC of the battery,
determine, based on the temperature difference and the SOC difference, a control voltage of the fuel cell stack,
determine, based on a ratio of an actual current of the fuel cell stack to a reference current of the fuel cell stack, a deterioration index associated with the fuel cell stack, and
adjust, based on the deterioration index, the control voltage, and
perform, based on the adjusted control voltage, at least one operation of the fuel cell stack.

2. The apparatus of claim 1, further comprising:
storage configured to store a lookup table indicating:
at least one control voltage,
at least one temperature difference between a target coolant temperature of the fuel cell stack and a current coolant temperature of the fuel cell stack, and
at least one SOC difference between a target SOC of the battery and a current SOC of the battery.

3. The apparatus of claim 2, wherein at least one instruction is configured, when executed by the processor communicating with the memory, to cause the apparatus to determine, based on the at least one temperature difference of the lookup table and the at least one SOC difference of the lookup table, the control voltage, wherein the determined control voltage corresponds to the determined temperature difference and the determined SOC difference.

4. The apparatus of claim 1, wherein the at least one instruction is configured, when executed by the processor communicating with the memory, to cause the apparatus to determine periodically the temperature difference and the SOC difference at preset intervals, and update periodically, based on the temperature difference and the SOC difference, the control voltage.

5. The apparatus of claim 1, wherein the at least one instruction is configured, when executed by the processor communicating with the memory, to cause the apparatus to determine the deterioration index by:
measuring the actual current of the fuel cell stack, and
determining, based on the control voltage, the reference current of the fuel cell stack.

6. The apparatus of claim 1, wherein the at least one instruction is configured, when executed by the processor communicating with the memory, to cause the apparatus to:
determine a first heat amount of the fuel cell stack and a first charge amount of the battery, wherein the first heat amount is less than an expected heat amount and the first charge amount is less than an expected charge amount due to deterioration of the fuel cell stack,
determine a second heat amount of the fuel cell stack and a second charge amount of the battery, wherein the second heat amount increases due to adjustment of the control voltage of the fuel cell stack, and
adjust the control voltage based on a voltage value that reduces a sum of a first difference and a second difference, wherein the first difference is a difference between the first heat amount of the fuel cell stack and the second heat amount of the fuel cell stack, and wherein the second difference is a difference between the first charge amount of the battery and the second charge amount of the battery.

7. The apparatus of claim 1, wherein the at least one instruction is configured, when executed by the processor communicating with the memory, to cause the apparatus to:
based on the coolant temperature of the fuel cell stack reaching the target coolant temperature of the fuel cell stack and the SOC of the battery reaching the target SOC of the battery, terminate the at least one operation of the fuel cell stack.

8. The apparatus of claim 7, wherein the at least one instruction is configured, when executed by the processor communicating with the memory, to cause the apparatus to activate, based on the at least one operation of the fuel cell stack being terminated, a cold shutdown function associated with the fuel cell stack.

9. A method performed by an apparatus of a vehicle, the method comprising:
detecting, via at least one sensor of the vehicle, a coolant temperature of a fuel cell stack and a state of charge (SOC) of a battery;
determining a temperature difference between the coolant temperature of the fuel cell stack and a target coolant temperature of the fuel cell stack and determining an SOC difference between the SOC of the battery and a target SOC of the battery;
determining, based on the temperature difference and the SOC difference, a control voltage of the fuel cell stack;
determining, based on a ratio of an actual current of the fuel cell stack to a reference current of the fuel cell stack, a deterioration index associated with the fuel cell stack;
adjusting, based on the deterioration index, the control voltage; and
performing, based on the adjusted the control voltage, at least one operation of the fuel cell stack.

10. The method of claim 9, further comprising:
storing a lookup table indicating:
at least one control voltage,
at least one temperature difference between a target coolant temperature of the fuel cell stack and a current coolant temperature of the fuel cell stack, and
at least one SOC difference between a target SOC of the battery and a current SOC of the battery.

11. The method of claim 10, wherein the determining the control voltage comprises determining, based on the at least one temperature difference of the lookup table and the SOC difference of the lookup table, the at least one control voltage, and wherein the determined control voltage corresponds to the determined temperature difference and the determined SOC difference.

12. The method of claim 9, wherein the determining the temperature difference and the SOC difference comprises determining periodically the temperature difference and the SOC difference at preset intervals.

13. The method of claim 9, wherein the determining the deterioration index comprises:
measuring, the actual current of the fuel cell stack; and
determining, based on the control voltage, the reference current of the fuel cell stack.

14. The method of claim 9, wherein the adjusting the control voltage comprises:
determining a first heat amount of the fuel cell stack and a first charge amount of the battery, wherein the first heat amount is less than an expected heat amount and the first charge amount is less than an expected charge amount due to deterioration of the fuel cell stack;
determining a second heat amount of the fuel cell stack and a second charge amount of the battery, wherein the second heat amount increases due to adjustment of the control voltage of the fuel cell stack; and
adjusting the control voltage based on a voltage value that reduces a sum of a first difference and a second difference, wherein the first difference is a difference between the first heat amount of the fuel cell stack and the second heat amount of the fuel cell stack, and wherein the second difference is a difference between the first charge amount of the battery and the second charge amount of the battery.

15. The method of claim 9, further comprising:
based on the coolant temperature of the fuel cell stack reaching the target coolant temperature and the SOC of the battery reaching the target SOC of the battery, terminating the at least one operation of the fuel cell stack.

16. The method of claim 15, further comprising:
activating, based on the at least one operation of the fuel cell stack being terminated, a cold shutdown function associated with the fuel cell stack.

17. An apparatus of a vehicle, the vehicle comprising:
a processor; and
a memory storing at least one instruction that is configured, when executed by the processor communicating with the memory, to cause the apparatus to:
detect a current temperature of a coolant of the fuel cell stack of the vehicle and a state of charge (SOC) of a battery of the vehicle;
determine a target condition based on at least one of:
a desired temperature adjustment of the current temperature of the coolant of the fuel cell stack, or
a desired charge level adjustment of the SOC of the battery;
determine, based on the target condition, a control voltage of the fuel cell stack;
adjust, based on a parameter indicative of a degraded condition of the fuel cell stack, the control voltage; and
perform, based on the adjusted control voltage, at least one operation of the fuel cell stack until the target condition is reached.

18. The apparatus of claim 17, wherein the at least one instruction is configured, when executed by the processor communicating with the memory, to cause the apparatus to update the parameter based on a difference between actual current of the fuel cell stack and expected current of the fuel cell stack.

19. The apparatus of claim 17, the processor is further configured to periodically adjust the control voltage based on changes in the degraded condition of the fuel cell stack.

20. The apparatus of claim 17, wherein the at least one instruction is configured, when executed by the processor communicating with the memory, to cause the apparatus to activate, based on the at least one operation being terminated, a shutdown function associated with the fuel cell stack.
